(19) United States
(12) Patent Application Publication
(10) Pub. No.: US 2025/0369141 A1
(43) Pub. Date: Dec. 4, 2025

(54) RECYCLING OF POLYMER MEMBRANES COMPRISING METAL-CONTAINING CATALYST MATERIAL

(71) Applicant: Siemens Energy Global GmbH & Co. KG, München (DE)

(72) Inventors: Konstantin Mierdel, Bamberg (DE); Christian Reller, Minden (DE); Yashar Musayev, Nürnberg (DE)

(21) Appl. No.: 18/875,196

(22) PCT Filed: Jun. 14, 2023
(86) PCT No.: PCT/EP2023/065880

§ 371 Date: Dec. 16, 2024

(30) Foreign Application Priority Data
Jun. 21, 2022 (DE) 10 2022 206 161.6

(51) Int. Cl. C25B 15/08; B01J 23/46; B01J 31/06; B01J 35/59; B01J 38/02; B01J 38/68; B01J 38/72; H01M 8/1069

(52) U.S. Cl. CPC C25B 15/087; B01J 23/468; B01J 31/06; B01J 35/59; B01J 38/02; B01J 38/68; B01J 38/72; H01M 8/1069

(57) ABSTRACT

The invention relates to a method for recycling polymer membranes comprising metal-containing catalyst material. The method comprises the following steps adding water without adding organic solvents to a polymer membrane comprising a metal-containing catalyst material to form a polymer membrane/water mixture, simultaneously increasing the pressure and the temperature of the polymer membrane/water mixture to a pressure between 20 bar and 40 bar and a temperature between 200° C. and 250° C., a liquid phase and a solid phase being formed, and separating the liquid phase and the solid phase.

### BACKGROUND

The invention relates to a method for recycling of polymer membranes comprising metal-containing catalyst material.

Hydrogen may be obtained from deionized water using electrolysis. For example, the electrolysis may be performed as a polymer electrolyte membrane (PEM) electrolysis, where the reaction chambers for the anode reaction (I) and the cathode reaction (II) are separated using a proton conductive membrane, the polymer electrolyte membrane, also known as proton exchange membrane.

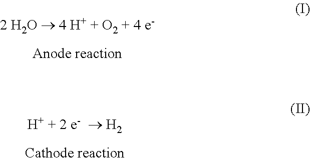

The polymer electrolyte membrane is typically formed from a polymer, particularly an ionomer. Perfluorosulphonic acid containing polymers, commercially available under the name Nafion™, for example, are commonly used.

Catalyst materials are typically applied into or onto the polymer electrolyte membrane in order to facilitate performing water electrolysis more efficiently. In English, a PEM coated with a catalyst material is also referred to as catalyst coated membrane, abbreviated as CCM. Potential catalyst materials are metals, such as iridium, platinum, ruthenium, palladium, for example, in form of pure metals or metallic compounds.

Similar polymer electrolyte membranes and catalyst materials are employed in fuel cells. The catalyst materials used in water electrolysis, contrary to catalyst materials used in fuel cells, often comprise iridium, as iridium is employed preferably for catalysis of the oxygen evolution reaction.

For example, upon expiration of the period of effective use or in case of faulty manufacture, recycling the polymer electrolyte membranes including catalyst materials for recovering the precious metals and membrane polymers is desirable for reasons of costs and environmental protection, among others.

Prior art recycling methods provide a two-stage combustion process at temperatures between 850 and 1,000° C., wherein the fluoropolymers are burnt while releasing HF and CO₂. Due to HF being aggressive, specific reactor linings as well as an extensive downstream gas scrubbing system is required. The resulting ashes are often mixed with other batches or ore concentrates and are supplied to a multi-stage refining process to separate the precious metals. One such refining process may provide dissolving in aqua regia, i.e., an HCl/HNO₃ mixture having a ratio of about 3:1.

However, if metallic iridium catalysts (Ir 0) are used, the possibility of dissolving in aqua regia is eliminated, as metallic iridium is not soluble. Therefore, the following separation operations for precious metal separation include the process of Na₂O₂ oxidation melting to convert metallic iridium to soluble IrO₂. This process yields only low conversions and needs to be repeated several times.

A significant disadvantage of the established process chain is the loss of the catalysts employed, as these become fully dissolved and need to be reprecipitated or pulverized. Due to the high number of process steps, process side streams are generated, which represent potential loss paths, as these may be integrated into the main process stream with an extensive effort only.

Also, recovering the membrane polymers is not possible, as these are burnt in the initial combustion process. The entire recycling method is also energy and time-consuming. Furthermore, using numerous chemicals results in generation of a plurality of toxins that require special deposit and represent a risk to the staff handling the recycling as well as to the environment.

U.S. Pat. No. 7,255,798 B2 discloses an alternative recycling method, where the CCM to be recycled is subjected to treatment in a water-solvent mixture at increased pressure and increased temperature. Solvents may include methanol, ethanol, n-propanol, isopropanol, n-butanol, 2-butanol, 2-methoxy ethanol, 2-ethoxy ethanol, ethylene glycol dimethyl ether, ethylene glycol diethyl ether, diethylene glycol dimethyl ether, diethylene glycol diethyl ether, dioxane, acetonitrile, or mixtures of the solvents mentioned having a mass percentage of between 10% and 80%. Subsequent to this treatment, the catalyst material and the polymer material may be separated from each other and processed further. For example, a membrane may be prepared again from the polymer material and the catalyst material may be deposited onto the membrane.

A disadvantage of this method is the use of mixtures of water and organic solvents, as this makes purification of the recycled polymer and catalyst material more difficult. Also, the organic solvents used represent hazardous substances, such that there is an increased risk for staff handling the recycling as well as for the environment, in particular in the context of increased pressure and high temperatures as process conditions.

### SUMMARY

In this context, it is an object of the invention to provide a method for recycling polymer membranes comprising metal-containing catalyst material, which help in reducing or even completely eliminating the issues mentioned above.

The object is achieved by the subject matter of the independent claim. The dependent claims relate to embodiments of the solutions according to the invention.

The invention relates to a method for recycling of polymer membranes comprising metal-containing catalyst material. The method comprises the following steps: Adding water without adding organic solvents to a polymer membrane comprising a metal-containing catalyst material to form a polymer membrane/water mixture, simultaneously increasing the pressure and the temperature of the polymer membrane/water mixture to a pressure between 20 bar and 40 bar and a temperature between 200° C. and 250° C., a liquid phase and a solid phase being formed, and separating the liquid phase and the solid phase.

The polymer membrane comprising the metal-containing catalyst material may be a polymer electrolyte membrane, for example, for use in water electrolysis or in a fuel cell. The polymer membrane may comprise polymerized perfluorosulphonic acid as polymer material, or the polymer material may consist of polymerized perfluorosulphonic acid, for example.

In addition to the polymer material, the polymer membrane comprises a metal-containing catalyst material, e.g., for catalysis of the aforementioned anode and/or cathode reactions (I, II) in the water electrolysis or the anode and/or cathode reactions in a fuel cell using hydrogen as a fuel. The metal-containing catalyst material may comprise one or more precious metals selected from the group consisting of iridium, platinum, ruthenium, rhodium, and palladium, each in form of metallic compounds, e.g., metal oxides, or pure metals.

For example, the method step of simultaneously increasing the pressure and the temperature may be performed as a hydrothermal treatment in an autoclave. The pressure in the range between 20 bar and 40 bar and the temperature in the range between, 200° C. and 250° C. need to be achieved simultaneously at least once. The specific duration of treatment depends on, but is not limited to, the chemical composition of the polymer material and the size of the polymer membrane parts to be treated. For example, the holding time may be 5 to 15 min, e.g., 10 min. The hydrothermal treatment facilitates the ability of the polymer chains to slide apart, such that the polymer material is dissolved in the water.

Preferably, the temperature may be increased to a temperature between 220° C. and 230° C. With temperatures above 250° C., the polymer may already start to degrade, with temperatures under 200° C., the polymer may not dissolve sufficiently.

Separating the liquid and solid phases may be performed using centrifugation, preferably at speeds of 10,000 to 15,000 revolutions per minute. Subsequently, metal-containing catalyst material and/or metal of the metal-containing catalyst material may be recovered from the separated solid phase.

The separated liquid phase contains dissolved polymer, which, depending on the concentration, may be reused either directly or following concentrating. In the method described, concentrating is particularly advantageous, as due to using water without adding organic solvents as a solvent, there is no need to account for different boiling points, such as, e.g., with water-alcohol mixtures.

The proposed method allows for recycling polymer membranes, in particular polymer electrolyte membranes, and the metal-containing catalyst materials contained therein or deposited thereon by separating the polymer and the metal-containing catalyst material from each other. This, following further recycling steps, if needed, allows for recovering and reusing the polymer and/or the metal-containing catalyst material.

As both the polymer material and the metal-containing catalyst material are rare and expensive materials, recycling is advantageously associated with conserving resources and reducing costs. Compared to the aforementioned combustion method, the proposed method has the advantage of being able to recover the polymer material in addition to the metal-containing catalyst material. Both the metal-containing catalyst material and the polymer material may be recovered without significant losses and in a substantially unchanged state, such that they may be reintegrated directly into the value chain. This results in further cost benefits and conservation of resources compared to conventional combustion processes with downstream precious metal refining. In the method described herein, the number of process steps is significantly reduced, that is from about 20 process steps in recycling by combustion to about six process steps, which allows for loss paths, particularly for iridium, to be avoided. There are no reprocessing costs for separation (separation process) and manufacturing costs for precipitating the new catalyst material.

The recycling process is performed without using organic solvents, i.e., for example, without adding alcohols, carboxylic acid esters, ethers, ketones, alkanes, aromatic hydrocarbons, glycol ethers, and nitriles. For example, the polymer membrane/water mixture may be formed by adding distilled water without any additives.

This may simplify the purification of the recycled polymer and catalyst material. In addition, the risk for staff handling the recycling as well as for the environment is reduced. The safety when performing the method may be increased particularly regarding the increased temperature and the increased pressure.

The treatment in water without adding organic solvents is advantageous particularly regarding the quantity of platinum catalysts. The platinum catalysts may otherwise react with the organic solvents mentioned and may present a safety hazard. In addition, subsequently concentrating the polymer solution will be significantly facilitated, as mentioned above.

Optionally, the polymer membrane comprising the metal-containing catalyst material may be ground prior to adding water, for example into segments with dimensions between 1 mm and 10 mm, preferably between 2 mm and 5 mm. Grinding may be performed by cutting or shredding, for example.

Grinding has the advantage that a more homogenous polymer membrane/water mixture may be formed, allowing for the hydrothermal treatment to be performed more efficiently, i.e., for example, holding times are reduced or a continuous process is simplified.

According to various embodiments, the polymer membrane may comprise a fiber reinforcement. In this case, the method may comprise separating fibers of the fiber reinforcement prior to separating the liquid phase and the solid phase.

The fibers may be in the form of a supporting tissue and comprise or be made of polyether ether ketone (PEEK), for example. Separating the fibers may be performed, for example, by sieving, e.g., using screens with a mesh size from 0.1 mm to 0.3 mm.

Separating the fibers may prevent the fibers from remaining in the solid phase, such that a solid phase of higher purity of the metal-containing catalyst material is obtained. This may avoid a downstream purification of the metal-containing catalyst material for removing the fibers or their components.

According to further embodiments, the method may comprise processing the separated solid phase.

As needed, different metal-containing catalyst materials or the metals contained therein, such as metallic iridium and platinum or platin-containing compounds, for example, may be separated from each other.

The processing may comprise one or more physical and/or chemical method steps, for example, treating with aqua regia, filtering, precipitating by adding a precipitant, washing, etc.

The specific selection of the processing steps depends on the metal-containing catalyst material present and the desired recycling product(s). The processing of the separated solid phase is performed for recovering the metal-containing catalyst material in metallic and/or chemically bound form, preferably such that it may be reused directly, for example, again as a catalyst material for catalysis in water electrolysis or in a fuel cell.

For example, the processing of the separated solid phase can be performed such that metallic iridium is obtained, e.g., as so-called Iridium Black in powder form. Since iridium-containing resources are particularly limited and obtaining iridium is complex and costly, recovering metallic iridium is particularly advantageous.

According to further embodiments, the method may comprise treating the separated liquid phase with activated carbon.

Activated carbon treatment allows for purifying the separated liquid phase from, for example, very small particles of the metal-containing catalyst material, which could not be separated by centrifugation.

This may increase the purity of the remaining aqueous polymer solution, such that the polymer solution may directly be processed further without another purification, following concentrating, if needed.

According to further embodiments, the method may comprise preparing a polymer membrane from the separated liquid phase.

The separated liquid phase comprises an aqueous solution of the polymer material of the polymer membrane. Polymer membranes may be prepared again from this solution, for example, by forming a layer, for example on a substrate, from the liquid phase and subsequently drying and annealing, if needed. For this purpose, coating methods for forming coating from liquid phases may be used, such as, e.g., spin coating, immersion coating, film-coating using a scraper.

Optionally, the separated liquid phase may be concentrated prior to applying the liquid phase. For this purpose, water may be removed using rotary evaporation, for example. Further optionally, prior to the rotary evaporation, n-propanol may be added to the liquid phase with a mass ratio of water: n-propanol=3:7, for example. Using n-propanol is preferred due to its boiling point being similar to that of water. This may increase cross-linking of the polymer during drying of the deposited layer, facilitating the subsequent formation of membranes, and potentially influencing specifically properties of the resulting membrane. A uniform withdrawal of the solvent may help to avoid any tears during subsequent drawing of membranes, as this allows for the polymer chains to cross-link evenly and be positioned smoothly next to each other. Otherwise, undesired micelles may be formed by the hydrophobic portions of the polymer backbone with n-propanol and the hydrophilic side chains with water.

Polymer membranes may advantageously be prepared again from the recycled polymer membrane, such that waste is avoided and resources are preserved.

Of course, for preparing polymer membranes, it is also possible to mix new polymer material with recycled polymer material.

According to further embodiments, the polymer membrane/water mixture may be stirred during the step of simultaneously increasing the pressure and the temperature.

The stirring rate may be 50 to 400 revolutions per minute, for example.

Stirring has the advantage that a more homogenous polymer membrane/water mixture may be formed, allowing for the hydrothermal treatment to be performed more efficiently, i.e., for example, holding times are reduced or a continuous process is simplified.

According to further embodiments, at least the step of simultaneously increasing the pressure and the temperature may be performed continuously.

In exemplary embodiments, further method steps may be performed continuously, such as, e.g., grinding the polymer membrane comprising the metal-containing catalyst material, adding water without adding organic solvents to the polymer membrane comprising the metal-containing catalyst material, separating fibers of the fiber reinforcement of the polymer membrane, processing the separated solid phase, and/or treating the separated liquid phase with activated carbon.

By performing the process continuously, higher throughputs may be achieved, resulting in the recycling being performed more efficiently.

### BRIEF DESCRIPTION OF THE DRAWINGS

The properties, features, and advantages described above, as well as the manner in which they are achieved, will be apparent and better understood in conjunction with the following description of the exemplary embodiments, which will be discussed in detail in reference to the drawings. In the drawings:

FIG. 1 shows a flow chart of an example method for recycling polymer membranes comprising metal-containing catalyst material;

FIG. 2 shows a pressure/temperature diagram for illustrating the conditions during the hydrothermal treatment;

FIG. 3 shows a diagram for illustrating the ion exchange capacity of new polymer membranes and polymer membranes from recycled polymer material; and

FIG. 4 shows a diagram for illustrating the equivalent weight of a new polymer membrane compared to polymer membranes from recycled polymer material.

### DETAILED DESCRIPTION

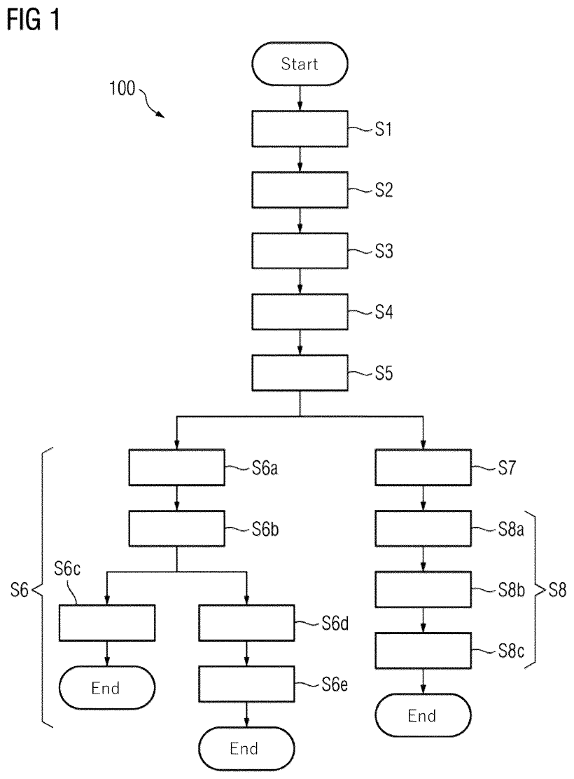

FIG. 1 shows a flow chart of an example method 100 for recycling polymer membranes comprising metal-containing catalyst material. The exemplary embodiment relates to recycling a perfluorosulphonic acid polymer membrane comprising a PEEK supporting tissue and metal-containing catalyst material. A 40 g membrane/electrode unit from the water electrolysis (Silyzer 300 module) having platinum catalysts on the cathode was used as starting material.

Upon starting the method 100, the polymer membrane comprising the metal-containing catalyst material was ground into cut segments with dimensions of about 3 mm in method step S1. A machine type Moco ZG 10 shredder having a throughput of 200 kg/h was used.

Subsequently, in method step S2, 235 g deionized water (without added organic solvents or other additives) was added to the cut segments, such that a polymer membrane/water mixture was formed.

In method step S3, this polymer membrane/water mixture was subjected to a hydrothermal treatment where pressure and temperature were increased simultaneously. In the exemplary embodiment, a laboratory autoclave having a volume of 700 ml was used, but continuous processing is also possible. In the exemplary embodiment, the hydrothermal treatment was performed for 10 min at a temperature of 225° C. and at a pressure of 24 bar. During the hydrothermal treatment, the perfluorosulphonic acid polymer dissolved, visible by foam forming on the resulting solution and an increased viscosity of the solution compared to water.

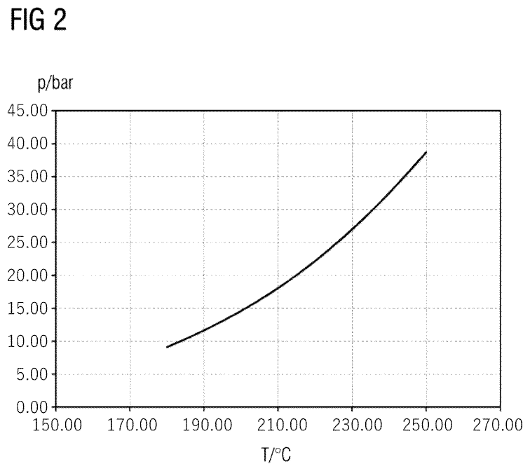

FIG. 2 shows a diagram, from which possible pressure/temperature conditions for performing method step S3 may be derived. In general, the pressure needs to be between 20 bar and 40 bar, while the temperature is between 200° C. and 250° C. In the exemplary embodiment, the hydrothermal treatment was performed at a temperature of 225° C. and at a pressure of about 23-24 bar.

Referring again to FIG. 1, the method 100, following the hydrothermal treatment, was continued with method step S4, where PEEK fibers, which had not dissolved in method step S3, were separated. For this purpose, large-meshed screens with a mesh size between 0.1 mm and 0.3 mm were used. If the polymer membrane does not have any fiber reinforcement, method step S4 may be omitted.

In method step S5, the solid and liquid phases formed following the hydrothermal treatment were separated. Here, the solid phase comprised the metal-containing catalyst material, whereas the perfluorosulphonic acid polymer was dissolved in the liquid phase. The separation of phases was performed by centrifugation at a speed of 11,500 revolutions per minute for a duration of 1 h. Following the separation of phases, the solid phase and the liquid phase were processed further separately.

The solid phase was processed in method step S6, the execution step being divided into steps S6a to S6e. In step S6a, aqua regia was added to the solid phase and the temperature was increased to about 80° C. This caused platinum contained therein to dissolve and to be separated by filtration in step S6b. Platinum was deposited or precipitated from the filtrate in step S6c. In step S6d, the filtration residue was washed using deionized water until a pH of 7 was achieved. Following drying in step S6e, metallic iridium in powder form was obtained, which may be employed again and directly, i.e., without additional conversion or purification steps, as a catalyst.

In order to process further the liquid phase obtained in method step S5, an optional treatment with activated carbon was performed in method step S7. The polymer solution, i.e., the ionomer phase, was purified. Following separation of the activated carbon, a purified aqueous solution of the perfluorosulphonic acid polymer was obtained.

In method step S8, a polymer membrane was prepared again from the obtained aqueous perfluorosulphonic acid polymer solution. The method step S8 is divided into steps S8a to S8c.

The preparation of the polymer membranes from recycled polymer was performed from the autoclaved polymer solution. In method step S8a, the polymer solution was concentrated in the rotary evaporator at a negative pressure between 60 mbar and 80 mbar and at a temperature of the heating bath of 40° C., wherein two different solvent mixtures were assessed. On the one hand, a concentration only of the polymer solution in the rotary evaporator was performed by withdrawing the water solvent. This could cause the polymer solution to foam heavily. On the other hand, prior to rotary evaporation, n-propanol was added with a ratio of water to n-propanol of 3:7. Since the perfluorosulphonic acid polymer easily dissolves in water, but water is strongly polar, another solvent was added to allow for the perfluorosulphonic acid to cross-link during the drying operation.

In the following step S8b, films were drawn from the concentrated solution onto a polyimide film (kapton film) using a scraper. The feed rate of the scraper was 10 mm/s. In step S8c, the drawn films were dried at 60° C. for 30 min in a drying cabinet and subsequently annealed at 180° C. for 10 min.

Polymer membranes without visible defects were obtained. In order to characterize the obtained polymer membranes, their ion exchange capacity and equivalent weight were determined.

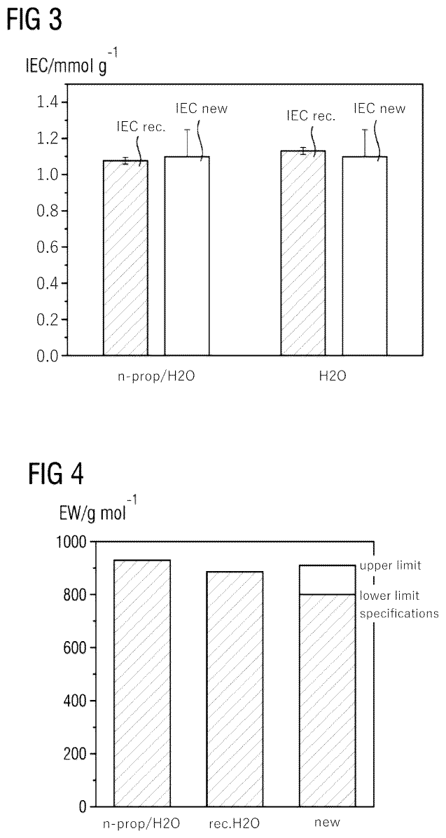

Recycling the polymer membranes should not result in damages to the polymer. The material properties of a polymer membrane from recycled polymer should approximately correspond to the properties of polymer membranes from new or juvenile polymer material. In order to characterize the polymer membranes from recycled polymer material, the ion exchange capacity IEC and the equivalent weight, which may be calculated therefrom, were determined. The results are summarized below and shown in FIGS. 3 and 4.

FIG. 3 compares the ion exchange capacity of the polymer membranes prepared from recycled polymer material (labelled as “IEC rec.”) and polymer membranes from new polymer material (labelled as “IEC new”) for each of the preparation of membranes from an aqueous solution (right side of the column diagram) and from an n-propanol/water mixture (ratio of water to n-propanol=3:7); left side of the column diagram). In case of the polymer membranes from recycled polymer material, the registered error bars represent the actual distribution of the measurements in five samples, whereas in case of the polymer membrane from new polymer material, they represent the range of manufacturer specifications.

The comparison according to FIG. 3 shows that the ion exchange capacity of the polymer membranes from recycled polymer material is in the lower range of the specification of a polymer membrane from new polymer material. In other words, the ion exchange capacity is affected only insignificantly by the recycling.

In addition, it may be derived from FIG. 3 that the ion exchange capacity of the polymer membrane from recycled polymer material when prepared from an aqueous solution is slightly higher than when prepared from the n-propanol/water mixture, while when using new polymer material, the ion exchange capacity does not depend on whether the membranes are prepared from an aqueous solution or the n-propanol/water mixture.

In addition, the ion exchange capacity has been converted to the equivalent weight EW of the polymer membranes (IEC)=(V(NaOH)*c (NaOH)/m0 in mmol/g; EW=1000/IEC in g/mol), and they have been plotted against each other in FIG. 4 (the label “rec. n-prop/H2O” corresponds to the polymer membrane from recycled polymer material, prepared from n-propanol/water mixture; “rec. H2O” corresponds to the polymer membrane from recycled polymer material, prepared from an aqueous solution, and “new” corresponds to the polymer membrane from new polymer material, wherein the value is independent from the preparation from an aqueous solution or the n-propanol/water mixture). The comparison of the equivalent weight of the polymer membranes illustrates that the values of the recycling membranes are within manufacturer specifications, and there is not any structural damage to the polymers resulting from the recycling.

It should therefore be noted that membranes prepared from recycled perfluorosulphonic acid polymer material using the method described do not comprise any damage to the perfluorosulphonic acid polymer caused by the recycling process.

In summary, the following advantages are associated with the proposed method increased recovery rates for the precious metals of more than 95%, obtaining the iridium catalyst, omitting re-synthesis, obtaining the ionomer dispersion suitable for preparing new membranes, mild process conditions, no emission of toxins, a resource-preserving ChemCycling process, a simple process chain without any special process technology, allows for direct replacement of the previous process step of combustion for recovering the precious metals and simultaneously recovering other resources, such as the polymer membrane, enabling emissions to be reduced and ensuring the availability of rare catalyst metals by utilizing resources in a highly efficient manner.

The method proposed is also suitable for recycling large quantities of polymer membranes comprising metal-containing catalyst material.

Although the invention has been illustrated and described in more detail by the preferred embodiment, the invention is not restricted by the disclosed examples and other variations may be derived from them by the person skilled in the art without departing from the scope of protection of the invention.

The term “and/or” used herein means when used in a series of two or more elements that each of the elements mentioned may be used individually, or any combination of two or more elements mentioned may be used.

1. A method for recycling polymer membranes comprising metal-containing catalyst material, the method comprising:
adding water without adding organic solvents to a polymer membrane comprising a metal-containing catalyst material to form a polymer membrane/water mixture;
simultaneously increasing a pressure and a temperature of the polymer membrane/water mixture to a pressure between 20 bar and 40 bar and a temperature between 200° C. and 250° C., a liquid phase and a solid phase being formed; and
separating the liquid phase and the solid phase.

2. The method according to claim 1, wherein the metal-containing catalyst material comprises one or more precious metals selected from the group consisting of iridium, platinum, ruthenium, rhodium, and palladium.

3. The method according to claim 1, comprising:
grinding the polymer membrane comprising the metal-containing catalyst material prior to adding water.

4. The method according to claim 1, comprising:
separating fibers of a fiber reinforcement of the polymer membrane prior to separating the liquid phase and the solid phase.

5. The method according to claim 1, comprising:
processing the separated solid phase.

6. The method according to claim 5, wherein metallic iridium is obtained during processing the solid phase.

7. The method according to claim 1, comprising:
treating the separated liquid phase with activated carbon.

8. The method according to claim 1, comprising:
preparing a polymer membrane from the separated liquid phase.

9. The method according to claim 1, wherein the polymer membrane/water mixture is stirred during the simultaneously increasing the pressure and the temperature.

10. The method according to claim 1, wherein at least the step of simultaneously increasing the pressure and the temperature is performed continuously.

11. The method according to claim 1, wherein the polymer membrane comprising the metal-containing catalyst material is a polymer electrolyte membrane for use in a water electrolysis or in a fuel cell.

12. The method according to claim 1, wherein the polymer membrane comprises a perfluorosulphonic acid polymer.

13. The method according to claim 1, wherein the temperature is increased to a temperature between 220° C. and 230° C. during simultaneously increasing the pressure and the temperature of the polymer membrane/water mixture.
